(19) United States
(12) Patent Application Publication
(10) Pub. No.: US 2009/0165991 A1
(43) Pub. Date: Jul. 2, 2009

(54) Air Conditioner

(75) Inventor: Akihiro Komaba, Tochigi (JP)

Correspondence Address: FOLEY AND LARDNER LLP;SUITE 500, 3000 K STREET NW, WASHINGTON, DC, 20007, US

(73) Assignee: CALSONIC KANSEI CORPORATION, Tokyo (JP)

(21) Appl. No.: 12/096,970

(22) PCT Filed: Dec. 11, 2006
(86) PCT No.: PCT/JP2006/324668

§ 371 Date: Jun. 11, 2008

(30) Foreign Application Priority Data
Dec. 12, 2005 (JP) 2005-358000

(51) Int. Cl. B60H 3/00

(52) U.S. Cl. 165/42

(57) ABSTRACT

An air conditioner includes, on a downstream side of a condenser 1, a mixing chamber to which a warm air path 4 and a bypass path 5 are connected and in which downstream sides of the warm air path 4 and the bypass path 5 merge together to mix flows of air coming therethrough, and a blowout path 7 connected to the mixing chamber 6. At a position where air speed of warm air having passed through a heat exchanger 2 is fast, an auxiliary heater 3 is provided through which a portion of the warm air passes, and is disposed in series with the heat exchanger 2. Another portion of the warm air passes through an area where the air speed of the warm air is slow thereby to bypass the auxiliary heater 3. Therefore, auxiliary heating can be made sufficiently by the auxiliary heater 3. Furthermore, another portion of the warm air passes through the area where the air speed is slow thereby to bypass the auxiliary heater 3, which suppresses a flow resistance of the warm air passing through the warm air path 4, thereby securing the volume of the warm air.

### TECHNICAL FIELD

The present invention relates to an air conditioner in which an electrically controlled auxiliary heater is provided on a downstream side of a heat exchanger for heating air (heater core).

### BACKGROUND ART

An air conditioner for vehicles generally has a heating heat exchanger (heater core) that heats air by utilizing hot water from a vehicle's engine (engine coolant), and heats a cabin of the vehicle by heating air taken from inside and outside the vehicle with this heat exchanger and then blowing the heated air to the vehicle cabin. Immediately after start of the vehicle, however, the engine is not warm and therefore the coolant temperature is low, so that the air cannot be heated with the heat exchanger. Particularly in a cold district, the heat exchanger is not enough to heat the air because outside temperature is extremely low. Therefore, there has been provided an auxiliary heater that is composed of an electric heater and the like for applying auxiliary heating to the air heated by the heat exchanger.

As a related art of this conventional technique, there has been disclosed an “air-conditioning device for vehicle” of Patent Document 1. This device includes: on a downstream side of a cooling condenser 101, a mixing chamber 106 to which a warm air path 104 and a bypass path 105 are connected and in which downstream sides of both the warm air path 104 and the bypass path 105 merge together to mix flows of air coming therethrough; a blowout path 107 connected to the mixing chamber 106; and an air mix door 108 that switches between the warm air path 104 and the bypass path 105, as shown in FIG. 5. The warm air path 104 has a heating heat exchanger 102 that heats air using an engine coolant of a vehicle and an auxiliary heater 103 composed of an electric heater and the like. This auxiliary heater 103 is disposed on a downstream side of the heat exchanger 102 in parallel therewith, and is small in height and size compared to the heat exchanger 102. According to this conventional technique, at the time of heating shown in FIG. 5, the air mix door 108 is rotated upward to open the warm air path 104 and close the bypass path 105. Therefore, when air taken from inside and outside of a vehicle passes through the warm air path 104, the air is heated by the heat exchanger 102, and then a portion of resultant warm air, which has passed through lower and middle parts of the heat exchanger 102 in a lengthwise direction thereof, is heated further by passing through the auxiliary heater 103, and another portion of the resultant warm air, which has passed through an upper part of the heat exchanger 102, passes through a space S above the auxiliary heater 103 to bypass the same.

There has also been disclosed an “air conditioner for vehicle” of Patent Document 2. This includes: on a downstream side of a condenser 111, an upper mixing chamber 117 to which a warm air path 114 having a heating heat exchanger 112 and an auxiliary heater 113 as well as bypass paths 115 and 116 are connected and in which downstream sides of the warm air path 114 and the upper bypass path 115 merge together to mix flows of air coming therethrough; a blowout path 118 connected to the upper mixture chamber 117; a lower mixing chamber 119 in which downstream sides of the warm air path 114 and the lower bypass path 116 merge together to mix flows of air coming therethrough; a blowout path 120 connected to the lower mixing chamber 119, an upper air mix door 121 that switches between the warm air path 114 and the upper bypass path 115; and a lower air mix door 122 that switches between the warm air path 114 and the lower bypass path 116, as shown in FIG. 6. The auxiliary heater 113 is disposed on a downstream side of the heat exchanger 112 in parallel therewith, and is equivalent in height to the heat exchanger 112. According to this conventional technique, at the time of heating shown in FIG. 6, the upper air mix door 121 is rotated upward and the lower air mix door 122 is rotated in a counterclockwise direction of FIG. 6 thereby to open the warm air path 114 and close the bypass paths 115 and 116. Therefore, when air taken from inside and outside a vehicle passes through the warm air path 114, the air is heated by the heat exchanger 112, and thereafter heated further by the auxiliary heater 103.

According to the conventional technique disclosed in Patent Document 1, however, when the warm air heated by the heating heat exchanger 102 passes through the warm air path 104, the volume of the warm air passing through the upper part of the heat exchanger 102 and the space S above the auxiliary heater 103 is large, and in contrast, the volume of the warm air passing through the lower or the middle part of the heat exchanger 102 in the lengthwise direction thereof and the auxiliary heater 103 is small, because the warm air is low in specific gravity and hence tends to rise, and also because flow resistance becomes smaller with decreasing distance over which the warm air flows. Furthermore, the auxiliary heater 103 has a flow resistance greater than that of the space S, and resultantly the proportion of the warm air passing through the auxiliary heater 103 is small, and the proportion of the warm air passing through the space S is large. Accordingly, a small volume of the warm air passing through the auxiliary heater 103 is heated further by the same and then blown out to a vehicle cabin after mixed with the warm air that has bypassed the auxiliary heater 103, which disadvantageously leads to a lack of heating because of a comparatively low temperature of this blown-out warm air. Moreover, hot water from the engine flows into the heat exchanger 102 from downward, and hence the lower side of the heat exchanger 102 reaches high temperature, which exerts a large heat influence on the auxiliary heater 103 that is disposed opposite to the lower and middle parts of the heat exchanger 102 in the lengthwise thereof. This produces a significant temperature difference of the warm air blown out from upper and lower sides of the auxiliary heater 103 immediately after it is activated, and afterwards, the auxiliary heater 103 disadvantageously suppresses heat generation thereof based on self-regulation.

Furthermore, according to the conventional technique disclosed in Patent Document 2, the auxiliary heater 113 is large in size and equivalent in height to the heat exchanger 112, and therefore the warm air passing through the warm air path 114 also passes through the auxiliary heater 113, thereby reducing the volume of the blown-out warm air because of flow resistance. Accordingly, when the warm air is heated further by the auxiliary heater 113 and then blown out to the vehicle cabin, this small volume of the blown-out warm air disadvantageously leads to a lack of heating.

The present invention has been made in consideration of the aforementioned conventional techniques, and an object thereof is to provide an air conditioner that can blows out a comparatively high temperature and large volume of warm air even in a condition that a heating heat exchanger cannot generate sufficient heat.

Patent Document 1: Japanese Patent Application Laid-Open No. 2003-34114 (paragraphs [0013] to [0020], FIG. 1)

Patent Document 2: Japanese Patent Application Laid-Open No. 2005-59808 (paragraphs [0035] to [0040], FIG. 1)

### DISCLOSURE OF INVENTION

In order to achieve the foregoing object, according to the present invention, there is provided an air conditioner that includes: on a downstream side of a cooling condenser, a mixing chamber to which a warm air path having a heating heat exchanger and a bypass path bypassing the warm air path are connected and in which downstream sides of the warm air path and the bypass path merge together to mix flows of air coming therethrough; and a blowout path connected to the mixing chamber. At a position where air speed of warm air having passed the heat exchanger is fast, an auxiliary heater is disposed in series with the heat exchanger so that a portion of the warm air passes through the auxiliary heater, and another portion of the warm air bypasses the auxiliary heater by passing through an area where the air speed of the warm air having passed the heat exchanger is slow.

According to the present invention having this constitution, when the warm air path is opened at heating, a portion of the warm air having passed the heat exchanger passes through the auxiliary heater at a fast air speed and hence in a large volume, so that auxiliary heating can be made sufficiently by the auxiliary heater. Furthermore, another portion of the warm air bypasses the auxiliary heater by passing through the area where the air speed is slow. Therefore, the flow resistance of the warm air passing through the warm air path can be suppressed, thereby securing a sufficient volume of the warm air. Accordingly, by heating further the warm air having passed through the heat exchanger by the auxiliary heater and then mixing the heated air with the warm air having bypassed the auxiliary heater, a comparatively high temperature and large volume of warm air can be blown even when the heating heat exchanger cannot generate sufficient heat.

According to the present invention, even when the heating heat exchanger cannot generate sufficient heat at the time of heating, a comparatively high temperature and large volume of warm air can be blown out. Therefore, an air conditioner can be obtained which provides sufficient heating even, for example, when an engine is not warmed up immediately after the start of a vehicle.

### BRIEF DESCRIPTION OF THE DRAWINGS

FIG. 1 is a cross section of an air conditioner according to an embodiment of the present invention;

FIG. 2 is a cross section along a line A-A of FIG. 1;

FIG. 3 is a front view of a heating heat exchanger provided in the embodiment;

FIG. 4 is a front view showing a modified example of the heating heat exchanger provided in the embodiment;

FIG. 5 is a cross section showing a conventional example of an air conditioner for vehicles; and

FIG. 6 is a cross section showing another conventional example of the air conditioner for vehicles.

### BEST MODE FOR CARRYING OUT THE INVENTION

An air conditioner according to an embodiment of the present invention will be described below with reference to the drawings.

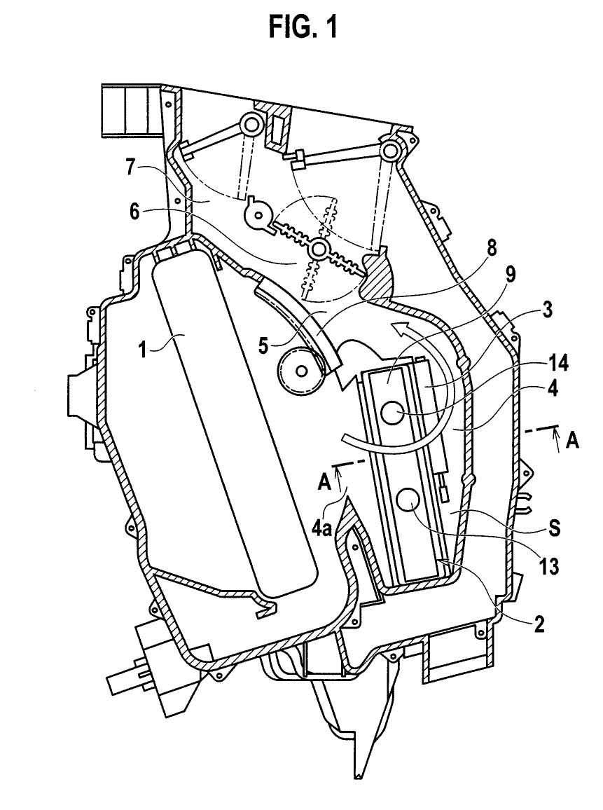

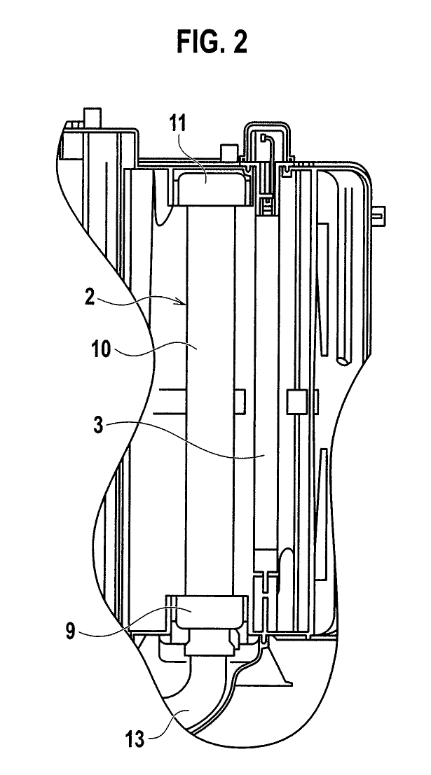

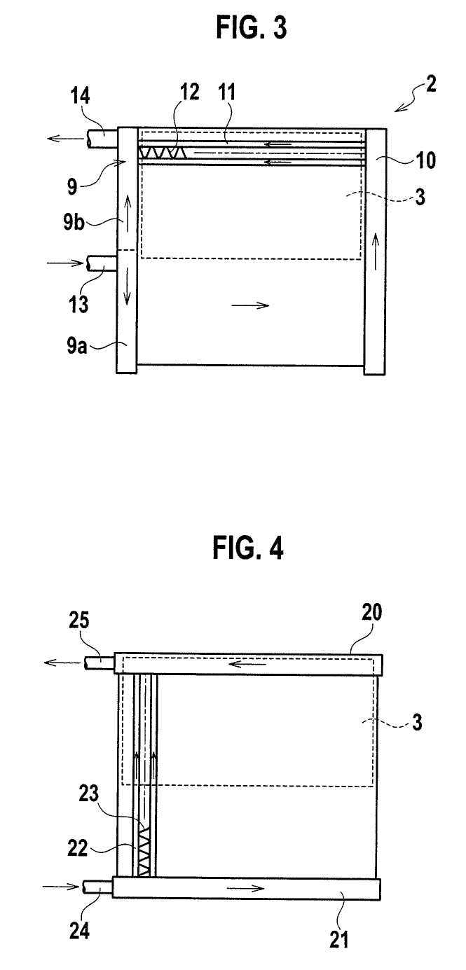

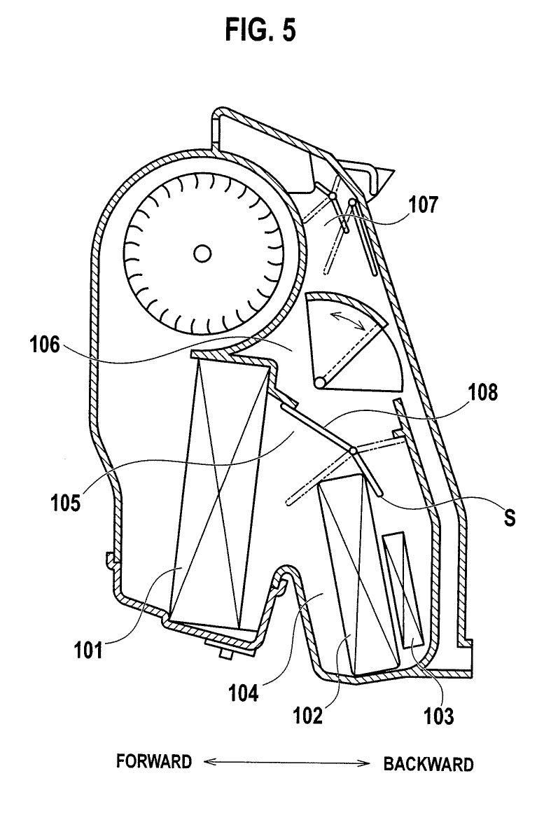

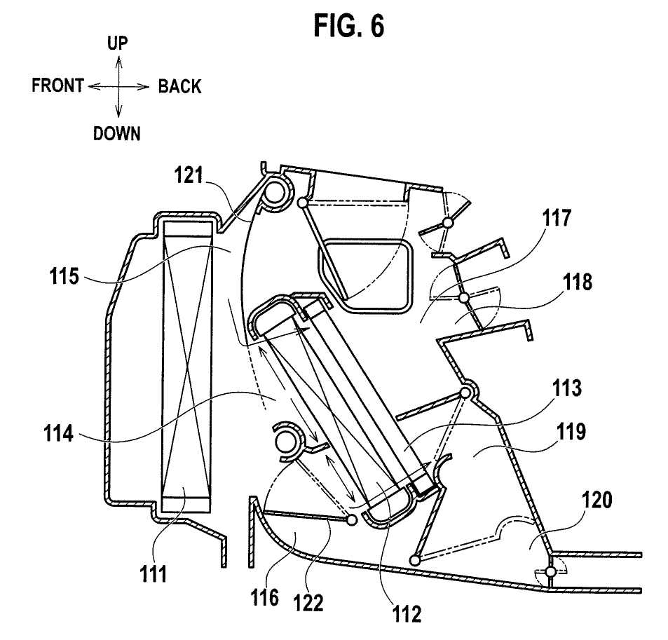

FIG. 1 is a cross section of the air conditioner according to the embodiment of the present invention, FIG. 2 is a cross section along a line A-A of FIG. 1, FIG. 3 is a front view of a heating heat exchanger provided in the embodiment, and FIG. 4 is a front view of a modified example of the heat exchanger provided in the embodiment.

Referring to FIGS. 1 and 2, the air conditioner in this embodiment includes: on a downstream side of a cooling condenser (evaporator) 1, a mixing chamber 6 to which a warm air path 4 having a heating heat exchanger 2 and an auxiliary heater 3 as well as a bypass path 5 bypassing the warm air path 4 are connected and in which downstream sides of both the warm air path 4 and the bypass path 5 merge together to mix flows of air coming therethrough; a blowout path 7 connected to the mixing chamber 6; and an air mix door 8 that switches between the warm air path 4 and the bypass path 5. The bypass path 5 is disposed at a position eccentric in an upward direction with respect to the condenser 1, and an inlet 4a of the warm air path 4 is disposed at a position eccentric in a downward direction with respect to the condenser 1. The warm air path 4 is connected to a side of the bypass path 5 while being curved.

The heating heat exchanger 2 is disposed in generally parallel with the condenser 1, and is eccentric in a downward direction with respect to the inlet 4a of the warm air path 4. On a downstream side of this heat exchanger 2, an auxiliary heater 3, which is small in height and size compared to the heat exchanger 2, is disposed in series and parallel with the heat exchanger 2. The auxiliary heater 3 is so placed as to face to the inlet 4a of the warm air path 4 (i.e., placed where air speed of warm air having passed through the heat exchanger 2 is fast), and a space S is formed under the auxiliary heater 3.

The heat exchanger 3 is composed of a hot-water circulation-type heat exchanger that generates heat by circulating hot water (engine coolant) from a vehicle engine, and includes a pair of tanks 9 and 10 provided to left and right sides, respectively, a plurality of hot water passages 11 connected to the tanks 9 and 10, and a plurality of fins 12 provided between the hot water passages 11, as shown in FIG. 3. The tank 9 is divided into a hot water inlet tank 9a positioned on a lower side and a hot water outlet tank 9b positioned on an upper side. A hot water inlet 13 provided to the hot water inlet tank 9a is disposed lower than a position opposite to the inlet 4a of the warm air path 4, and a hot water outlet 14 provided to the hot water outlet tank 9b is disposed at the position opposite to the inlet 4a of the warm air path 4.

The auxiliary heater 3 is composed, for example, of a PTC heater, and has a PCT stone that generates heat when energized, a base (position frame) on which the PCT stone is mounted, and upper and lower fins that holds the PCT stone therebetween, none of which are shown. Through these upper and lower fins, air is warmed.

In this embodiment, at the time of heating, the air mix door 8 is raised thereby to close the bypass path 5 and open the inlet 4a of the warm air path 4, as shown in FIG. 1. In this condition, the air having passed through the condenser 1 enters the inlet 4a of the warm air path 4 and then heated by the heat exchanger 2. Afterwards, a portion of the resultant warm air is heated further by passing through the auxiliary heater 3. At the same time, another portion of the resultant warm air passes through an area below the position opposite to the inlet 4a of the warm air path 4 (i.e., an area where air speed of the warm air is slow), and bypasses the auxiliary heater 3 by passing through a space S under the auxiliary heater 3. Thereafter, the heated warm air and the bypass warm air are mixed in the warm air path 4 and then blown out through the mixing chamber 6 from the blowout path 7 to a vehicle cabin and the like.

According to this embodiment, a portion of the warm air having passed through the heat exchanger 2 passes through the auxiliary heater 3 at a fast speed and hence in large volume, so that auxiliary heating can be made sufficiently by the auxiliary heater 3. Furthermore, another portion of the warm air bypasses the auxiliary heater 3 by passing through the area where the air speed of the warm air is slow, so that the flow resistance of the warm air passing through the warm air path 4 is suppressed, which ensures the volume of the warm air. Therefore, at the time of heating, a comparatively high temperature and large volume of the warm air can be blown even when the heat exchanger 2 cannot generate sufficient heat.

Furthermore, according to this embodiment, the hot water inlet 13 is disposed lower than the position opposite to the inlet 4a of the warm air path 4, and a high temperature region of the heat exchanger 2 in a lower part thereof is away from the auxiliary heater 3, so that the influence of heat on the auxiliary heater 3 becomes comparatively small. Therefore, it is possible to reduce the temperature difference of the warm air blown out from the upper and lower sides of the auxiliary heater 3 immediately after it is activated, and it is also possible to prevent the auxiliary heater 3 from suppressing the heat generation based on self-regulation.

For example, according to a heating performance test made by the applicant of the present invention, when an air blowout volume was 250 m³/h, a temperature of the blown-out air was 36.3 C° in the case that the heating heat exchanger 2 was used for heating and the auxiliary heater 3 was not activated, and a temperature of the blown-out air was 43.8 C° in the case that both the heat exchanger 2 and the auxiliary heater 3 were used for heating. This means that the activation of the auxiliary heater 3 increased the temperature of the blown-out air by 7.5 C°. Furthermore, when an air blowout volume was 290 m³/h, a temperature of the blown-out air was 35.4 C° in the case that the heat exchanger 2 was used for heating and the auxiliary heater 3 was not activated, and a temperature of the blown-out air was 41.5 C° in the case that both the heat exchanger 2 and the auxiliary heater 3 were used for heating. This means that the activation of the auxiliary heater 3 increased the temperature of the blown-out air by 6.1 C°. Note that at this heating performance test, outside air temperature was −10 C°, hot water temperature was 50 C°, flow rate of the hot water was 6 L/min, voltage of the auxiliary heater 3 was 13V (constant), and the auxiliary heater 3 was activated on all stages (three stages).

The foregoing embodiment has handled the case that the heat exchanger 3 has the pair of tanks 9 and 10 on left and right sides, respectively, and the present invention is, however, limited to this case. The same advantageous effect as in the foregoing embodiment can be obtained even when the heat exchanger 2 is composed of a pair of tanks 20 and 22 provided on upper and lower sides, respectively, a plurality of hot water passages 22 connected to these tanks 20 and 21, and a plurality of fins 23 provided between the hot water passages 22, a hot water inlet 24 is connected to one end of the lower tank 21, and a hot water outlet 25 is connected to one end of the upper tank 20, as shown in FIG. 4.

### INDUSTRIAL APPLICABILITY

The present invention advantageously provides an air conditioner that perform sufficient heating even when an engine is not warmed up immediately after the start of a vehicle, so that it is applicable as an air conditioner for vehicles in a cold district and also widely applicable as an air conditioner for general and industrial machinery.

1. An air conditioner including, on a downstream side of a cooling condenser, a mixing chamber to which a warm air path having a heating heat exchanger and a bypass path bypassing the warm air path are connected, and in which downstream sides of the warm air path and the bypass path merge together to mix flows of air coming therethrough, and a blowout path connected to the mixing chamber, the air conditioner comprising:
an auxiliary heater provided at a position where air speed of warm air having passed through the heat exchanger is fast, the auxiliary heater being disposed in series with the heat exchanger, wherein
a portion of the warm air passes through the auxiliary heater, and another portion of the warm air passes through an area where the air speed is slow to bypass the auxiliary heater.

2. An air conditioner including, on a downstream side of a cooling condenser, a mixing chamber to which a warm air path and a bypass path bypassing the warm air path are connected and in which downstream sides of the warm air path and the bypass path merge together to mix flows of air coming therethrough, the warm air path having therein a heating heat exchanger disposed in generally parallel with the condenser, and a blowout path connected to the mixing chamber, the air conditioner comprising:
an auxiliary heater smaller than the heat exchanger, the auxiliary heater being disposed in series with the heat exchanger and opposite to an inlet of the warm air path, wherein
the bypass path is disposed at a position eccentric in an upward direction with respect to the condenser,
the inlet of the warm air path is disposed at a position eccentric in a downward direction with respect to the condenser,
the warm air path is connected to the bypass path while being curved,
the heat exchanger is disposed at a position eccentric in a downward direction with respect to the inlet of the warm air path,
a portion of warm air having passed through the heat exchanger passes through the auxiliary heater, and
another portion of the warm air passes through a space below the auxiliary heater to bypass the same.

3. The air conditioner according to claim 1, wherein the heat exchanger is composed of a hot-water circulation-type heat exchanger that generates heat by circulating hot water, and a hot water inlet of the hot-water circulation-type heat exchanger is disposed lower than a position opposite to the inlet of the warm air path.

4. The air conditioner according to claim 3, wherein
the heat exchanger has a pair of tanks provided on both sides, a plurality of hot water passages connected to the tanks, and a plurality of fins provided between the hot water passages,
one of the tanks is divided into a hot water inlet tank and a hot water outlet tank, and
a hot water inlet provided to the hot water inlet tank is disposed lower than the position opposite to the inlet of the warm air path.

5. The air conditioner according to claim 2, wherein the heat exchanger is composed of a hot-water circulation-type heat exchanger that generates heat by circulating hot water, and a hot water inlet of the hot-water circulation-type heat exchanger is disposed lower than a position opposite to the inlet of the warm air path.
